(19) United States
(12) Patent Application Publication
(10) Pub. No.: US 2022/0043509 A1
(43) Pub. Date: Feb. 10, 2022

(54) GAZE TRACKING

(71) Applicant: Tobii AB, Danderyd (SE)

(72) Inventors: Anders Dahl, Danderyd (SE); Tommaso Martini, Danderyd (SE); Oscar Danielsson, Danderyd (SE); Mårten Nilsson, Danderyd (SE); Patrik Barkman, Danderyd (SE)

(73) Assignee: Tobii AB, Danderyd (SE)

(21) Appl. No.: 16/915,345

(22) Filed: Jun. 29, 2020

(30) Foreign Application Priority Data
Jun. 28, 2019 (SE) 1950821-7

(51) Int. Cl. G06F 3/01; G06N 20/00; B60K 35/00; G06K 9/00; B60R 1/00

(52) U.S. Cl. CPC G06F 3/013; G06F 3/014; G06N 20/00; B60K 35/00; B60R 2300/8046; B60R 1/00; B60K 2370/345; B60K 2370/349; G06K 9/00845

(57) ABSTRACT

A system configured to enable operation of an apparatus based on the gaze of a user, the system comprising a processor, and a memory comprising instructions executable by the processor, wherein the system is configured to determine a gaze region of a user among a plurality of regions associated with the apparatus, wherein the plurality of regions comprises at least one primary gaze region and at least one secondary gaze region and perform at least one action based on the determination of the gaze region, wherein the system is configured to determine the gaze region using a first gaze estimation algorithm and/or a second gaze estimation algorithm.

### CROSS REFERENCE TO RELATED APPLICATIONS

This application claims priority to Swedish Application No. 1950821-7 filed Jun. 28, 2019; the content of which are hereby incorporated by reference.

### FIELD

The present disclosure generally relates to controlling an apparatus based on a gaze of a user. More specifically, the present disclosure generally relates to a system and method for determining a gaze region of a user and performing an appropriate action.

### BACKGROUND

Gaze estimation and eye tracking systems use the gaze of a user to control an apparatus, for example by determining a gaze point of a user and interacting with an icon on a screen when the user's gaze point is on that icon. Such systems generally have a working range, within which the determined gaze point of the user can be considered reliable. To be within this working range, the user needs to be in the correct position, for example directly in front of an image capture device of the system. Furthermore, the user may have to have the correct head pose, for example upright and front-on to the image capture device. The user may have to have the correct gaze angle, for example a gaze direction within 90° either side of a central gaze position (the user's eyes looking forward). Outside of this range, the system may not be able to capture the necessary information, for example a reflection from the cornea of the user, to produce a reliable signal.

However, many current gaze estimation systems output a gaze point signal even when the user is outside the working range of the system. For example, if the user is paying attention to something other than the screen, a gaze point signal may still be produced which would not accurately represent where the user is looking. This can cause issues with interpreting that signal and controlling an associated apparatus accordingly.

Therefore, a system and method is required that can provide a reliable gaze signal when the user is outside the working range of current gaze estimation systems and which enable the system to take appropriate actions in response to those signals.

### SUMMARY

The present disclosure provides a system and method for determining a gaze region of a user, and takes appropriate action dependent on whether the region is a primary gaze region for a user or another, secondary gaze region, for example outside the primary gaze region. A primary gaze region could be a computer screen or display device associated with a computer. In this case, secondary gaze regions could be any off-screen regions. Another example of primary gaze region is a straight-ahead view of a car, where a control or entertainment panel, the rear-view or wing mirrors could be the secondary gaze regions. Current gaze estimation systems focus on estimating gaze points in primary gaze regions. The disclosed system and method first determines a gaze region, and then takes appropriate action.

By taking this approach, many advantages are realised. For example, determination of a gaze region can be performed by using a different, lower-accuracy gaze estimation algorithm from those used to determine gaze points in current gaze estimation systems. In this way, the higher-accuracy algorithms that are typically used can be implemented only when needed or able to provide a reliable signal. This saves computing resources associated with running the higher-accuracy algorithm all the time, as well as ensuring erroneous signals are not used to control an associated apparatus. For the lower-accuracy algorithm, head-pose or pupillary position estimation, as well as machine learning algorithms, can be used instead of corneal reflection, which means that complex technology such as illuminators is not necessarily required. If it is determined that the user is not looking within a primary gaze region, appropriate action can be taken, such as highlighting devices outside the primary gaze region to enable easier interaction with such devices.

In accordance with an aspect of the disclosure there is provided a system configured to enable operation of an apparatus based on the gaze of a user, the system comprising a processor, and a memory comprising instructions executable by the processor, wherein the system is configured to determine a gaze region of a user among a plurality of regions associated with the apparatus, wherein the plurality of regions comprises at least one primary gaze region and at least one secondary gaze region, and perform at least one action based on the determination of the gaze region, wherein the system is configured to determine the gaze region using a first gaze estimation algorithm and/or a second gaze estimation algorithm.

Optionally, the system is configured to determine the gaze region using only the first gaze estimation algorithm. Optionally, the system is further configured to determine a gaze region using the first gaze estimation algorithm, determine a gaze region using the second gaze estimation algorithm, and select either the gaze region determined by the first gaze estimation algorithm or the gaze region determined by the second gaze estimation algorithm. Optionally, the first and second gaze estimation algorithms are configured to yield respective confidence signals associated with their respective determined gaze regions, and if the gaze regions determined by the first and second gaze estimation algorithms are different, the system is configured to select the gaze region having the highest confidence signal.

Optionally, the first gaze estimation algorithm comprises a head pose estimation algorithm configured to determine the gaze region based on a head pose of the user. Optionally, the first gaze estimation algorithm is configured to determine a gaze region by determining a pupillary position of at least one eye of the user with respect to a plurality of facial landmarks, optionally at least three facial landmarks. Optionally, the first gaze estimation algorithm comprises a machine-learning based gaze estimation algorithm optionally trained based on a plurality of ground truth gaze locations generated by an apparatus rendering a visual stimulus, wherein the ground truth gaze locations optionally comprise two-dimensional and/or three-dimensional locations.

Optionally, the second gaze estimation algorithm comprises a pupil centre cornea reflection “PCCR” algorithm. Optionally, the second gaze estimation algorithm comprises a machine-learning based gaze estimation algorithm optionally trained based on a plurality of ground truth gaze locations generated by a display device rendering a visual stimulus, wherein the ground truth gaze locations optionally comprise two-dimensional and/or three-dimensional locations.

Optionally, the system further comprises an image capture device, wherein the system is further configured to determine the gaze region using the image capture device. Optionally, the system further comprises an eye-tracking system comprising the image capture device and at least one illuminator, wherein the system is configured to determine the gaze region using the eye-tracking system. Optionally, the at least one primary gaze region comprises locations that produce at least one corneal reflection detectable by the eye-tracking system when the user looks at such locations.

Optionally, if the determined gaze region is a primary gaze region, performing at least one action comprises determining a refined gaze region that is smaller than the primary gaze region and located within the primary gaze region. Optionally, determining the refined gaze region comprises using the second gaze estimation algorithm. Optionally, performing at least one action further comprises controlling the apparatus based on the refined gaze region, wherein the refined gaze region is optionally a gaze point of the user.

The system of any preceding claim, wherein the at least one primary gaze region comprises at least part of a display device associated with the apparatus. Optionally, if the determined gaze region is a secondary gaze region, performing at least one action comprises reducing the brightness of the display device.

Optionally, if the determined gaze region is a secondary gaze region, performing at least one action comprises determining if the secondary gaze region is associated with a user input device associated with the apparatus, and, if so, highlighting at least part of the user input device. Optionally, highlighting at least part of the user input device comprises activating built-in illumination of the user input device. Optionally, the user input device comprises a keyboard and/or a pointing device.

Optionally, the apparatus is a computer associated with a vehicle, the at least one primary gaze region corresponds to a straight-ahead view, an instrument panel and/or entertainment panel of the vehicle, the at least one secondary gaze region corresponds to a side-view mirror and/or rear-view mirror of the vehicle, and performing said at least one action optionally comprises causing the computer to control an illumination level of the instrument panel and/or entertainment panel, and/or generate at least one audio or visual signal to direct the attention of the user to the straight-ahead view, the instrument panel, entertainment panel, side-view mirror and/or rear-view mirror.

Optionally, at least one primary gaze region overlaps at least one secondary gaze region.

In accordance with another aspect of the disclosure there is provided a method of operating an apparatus based on the gaze of a user, the method comprising determining a gaze region of a user among a plurality of regions associated with the apparatus, wherein the plurality of regions comprises at least one primary gaze region and at least one secondary gaze region, and performing at least one action based on the determination of the gaze region, wherein determining the gaze region comprises using a first gaze estimation algorithm and/or a second gaze estimation algorithm.

Optionally, determining the gaze region comprises using only the first gaze estimation algorithm. Optionally, the method further comprises determining a gaze region using the first gaze estimation algorithm, determining a gaze region using the second gaze estimation algorithm, and selecting either the gaze region determined by the first gaze estimation algorithm or the gaze region determined by the second gaze estimation algorithm. Optionally, the first and second gaze estimation algorithms are configured to yield respective confidence signals associated with their respective determined gaze regions, and if the gaze regions determined by the first and second gaze estimation algorithms are different, the method comprises selecting the gaze region having the highest confidence signal.

Optionally, the first gaze estimation algorithm comprises a head pose estimation algorithm configured to determine the gaze region based on a head pose of the user. Optionally, using the first gaze estimation algorithm comprises determining a pupillary position of at least one eye of the user with respect to a plurality of facial landmarks, optionally at least three facial landmarks. Optionally, the first gaze estimation algorithm comprises a machine-learning based gaze estimation algorithm optionally trained based on a plurality of ground truth gaze locations generated by an apparatus rendering a visual stimulus, wherein the ground truth gaze locations optionally comprise two-dimensional and/or three-dimensional locations.

Optionally, the second gaze estimation algorithm comprises a pupil centre cornea reflection “PCCR” algorithm. Optionally, the second gaze estimation algorithm comprises a machine-learning based gaze estimation algorithm optionally trained based on a plurality of ground truth gaze locations generated by a display device rendering a visual stimulus, wherein the ground truth gaze locations optionally comprise two-dimensional and/or three-dimensional locations.

Optionally, the method further comprises determining the gaze region using an image capture device. Optionally, the method further comprises determining the gaze region using an eye-tracking system comprising the image capture device and at least one illuminator. Optionally, the at least one primary gaze region comprises locations that produce at least one corneal reflection detectable by the eye-tracking system when the user looks at such locations.

Optionally, if the determined gaze region is a primary gaze region, performing at least one action comprises determining a refined gaze region that is smaller than the primary gaze region and located within the primary gaze region. Optionally, determining the refined gaze region comprises using the second gaze estimation algorithm. Optionally, performing at least one action further comprises controlling the apparatus based on the refined gaze region. Optionally, the refined gaze region is a gaze point of the user.

Optionally, the at least one primary gaze region comprises at least part of a display device associated with the apparatus. Optionally, if the determined gaze region is a secondary gaze region, performing at least one action comprises reducing the brightness of the display device.

Optionally, if the determined gaze region is a secondary gaze region, performing at least one action comprises determining if the secondary gaze region is associated with a user input device associated with the apparatus, and, if so, highlighting at least part of the user input device. Optionally, highlighting at least part of the user input device comprises activating built-in illumination of the user input device. Optionally, the user input device comprises a keyboard and/or a pointing device.

Optionally, the apparatus is a computer associated with a vehicle, the at least one primary gaze region corresponds to a straight-ahead view, an instrument panel and/or entertainment panel of the vehicle, the at least one secondary gaze region corresponds to a side-view mirror and/or rear-view mirror of the vehicle, and performing at least one action optionally comprises causing the computer to control an illumination level of the instrument panel and/or entertainment panel, and/or generate at least one audio or visual signal to direct the attention of the user to the straight-ahead view, the instrument panel, entertainment panel, side-view mirror and/or rear-view mirror.

Optionally, at least one primary gaze region overlaps at least one secondary gaze region.

In accordance with another aspect of the disclosure there is provided a computer program comprising instructions which, when executed on at least one processor, cause the at least one processor to carry out the method. In accordance with another aspect of the disclosure there is provided a carrier containing the computer program, wherein the carrier is one of an electronic signal, optical signal, radio signal, or computer readable storage medium.

### BRIEF DESCRIPTION OF THE DRAWINGS

Exemplary embodiments of the disclosure shall now be described with reference to the drawings in which:

FIG. 1 illustrates an environment comprising an apparatus with a plurality of associated gaze regions according to an embodiment;

FIG. 2 illustrates an environment associated with an apparatus with a plurality of associated gaze regions according to an embodiment;

FIG. 3 is a flow chart illustrating a method of operating an apparatus based on the gaze of a user according to an embodiment;

FIG. 4 is a block diagram of an exemplary computer system capable of being used in at least some portion of the devices or systems of the present invention, or implementing at least some portion of the methods of the present invention.

Throughout the description and the drawings, like reference numerals refer to like parts.

### SPECIFIC DESCRIPTION

The present invention will now be described more fully hereinafter. The invention may, however, be embodied in many different forms and should not be construed as limited to the embodiments set forth herein; rather, these embodiments are provided by way of example so that this disclosure will be thorough and complete, and will fully convey the scope of the invention to those users skilled in the art.

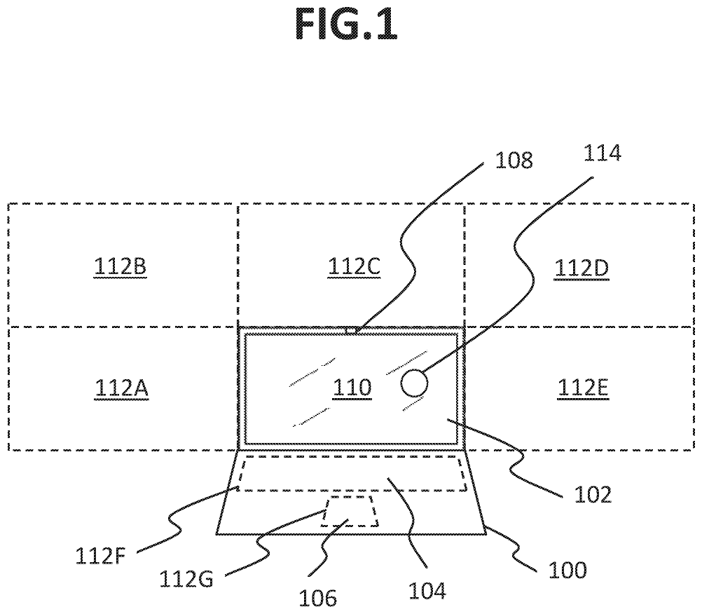

FIG. 1 an environment comprising an apparatus. In this embodiment, the apparatus is a laptop computer 100 having a screen 102, a keyboard 104, a trackpad 106 and an image capture device 108. It will be appreciated that the apparatus could be any apparatus capable of being controlled by the gaze of a user, for example a desktop computer, smartphone, tablet, on-board computing device of a vehicle, virtual reality (VR) headset or augmented reality (AR) glasses.

The apparatus is associated with a number of possible gaze regions of the user. In the example of FIG. 1, a first gaze region 110 corresponds to the screen 102 of the laptop computer 100. This can be considered as a region of primary focus of the user, or a primary gaze region, as it is expected that during operation of the apparatus the user will primarily be looking at the screen 102. Other regions 112 associated with the apparatus correspond to other areas in the environment. In particular, these may be regions that do not correspond to the screen 102. As such, these can be considered as regions of secondary focus of the user, or secondary gaze regions. In the embodiment of FIG. 1, there are seven secondary gaze regions 112 A-G. These comprise a number of regions arranged immediately around the screen: a left region 112A, a top-left region 112B, a top region 112C, a top-right region 112D, and a right region 112E. There may also be a keyboard region 112F corresponding to the keyboard 104 of the laptop computer 110, and a trackpad region 112G, corresponding to the trackpad 106 of the laptop computer. A refined gaze region 114 may also be present.

It will be appreciated that the specific arrangement of regions 110, 112 in FIG. 1 is for example purposes only, and other arrangements of regions associated with an apparatus could equally be envisaged. In some embodiments, more than one primary gaze region may be present. For example, the environment may comprise a number of screens associated with an apparatus, and each screen may correspond to its own respective primary gaze region. Whilst the secondary gaze regions 112A-E are shown as being adjacent to the primary gaze region 110 and to each other, it will be envisaged that there could be a gap between the regions, or the regions could overlap.

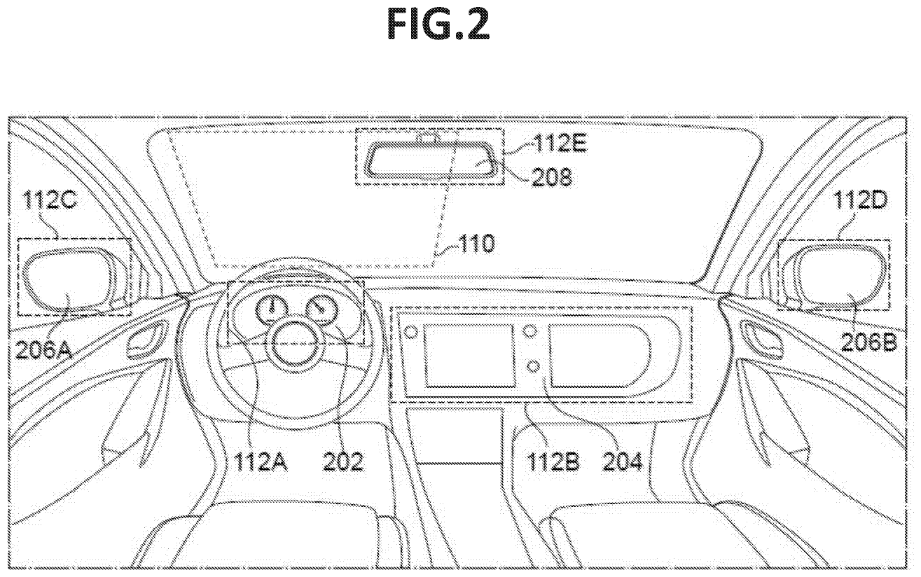

Another example environment associated with an apparatus capable of being controlled by the gaze of a user is shown in FIG. 2. In this embodiment, the apparatus is the on-board computing device of the car (not shown). The car has a number of display/view related features, including an instrument panel or heads-up display 202, an entertainment panel 204, a left wing mirror 206A, a right wing mirror 206B, and a rear-view mirror 208. The car also has an image capture device or eye-tracking system (not shown) to enable determination of the gaze of the user. The environment can be divided into a number of possible gaze regions of the user. In the embodiment shown, a primary gaze region 110 corresponds to a straight-ahead view, where the user is looking at the road. This can be considered as a region of primary focus of the user, as it is expected that, when driving, the user will primarily be looking at the road. The display/view related features may each have their own associated secondary region. In FIG. 2, the region 112A corresponds to the instrument panel 202, the region 112B corresponds to the entertainment panel 204, the region 112C corresponds to the left wing mirror 206A, the region 112D corresponds to the right wing mirror 206B, and the region 112D corresponds to the rear-view mirror 208. In this embodiment, it can be seen that the gaze regions are not adjacent, and that the primary gaze region 110 and secondary gaze region 112E overlap.

It will be appreciated that the specific arrangement of regions 110, 112 in FIG. 2 is for example purposes only, and other arrangements of regions associated with a vehicle could equally be envisaged. For example, in some embodiments, the gaze regions corresponding to the instrument panel 202 and the entertainment panel 204 could also be considered as primary regions. It will also be appreciated that, whilst the arrangement in car is shown in FIG. 2, a similar approach could be used in any vehicle comprising an apparatus capable of being controlled by the gaze of a user.

As discussed, in order to determine the gaze region of a user, an image capture device may be present in the environment. The image capture device can be used to capture images of the user which allow the gaze region to be determined. For example, the image capture device may capture images showing the head position and/or a pupillary position of the user.

In some embodiments, an eye tracking system associated with or comprising the image capture device may be present in the environment. The eye tracking system may be for determining a gaze point or a gaze region of a user, or a change in the gaze point gaze point or gaze region. Eye tracking system and methods, sometimes referred to as gaze detection systems and methods, include, for example, products produced and available from Tobii Technology AB, and which operate by using infrared illumination and an image sensor to detect reflection from the eye of a user. An example of such a gaze detection system is described in U.S. Pat. No. 7,572,008. Other alternative gaze detection systems may also be employed by the invention, regardless of the technology behind the gaze detection system. The eye tracking system may employ its own processor or the processor of another device (i.e., the processor/computer) to interpret and process data received. When an eye tracking system is referred to herein, both possible methods of processing data are referred to. In the context of the present disclosure, when such an eye tracking system is used, a primary gaze region may be defined as the region that defines the working range of the eye tracking system. That is to say, a primary gaze region comprises locations that produce at least one corneal reflection detectable by the eye-tracking system when the user looks at such locations.

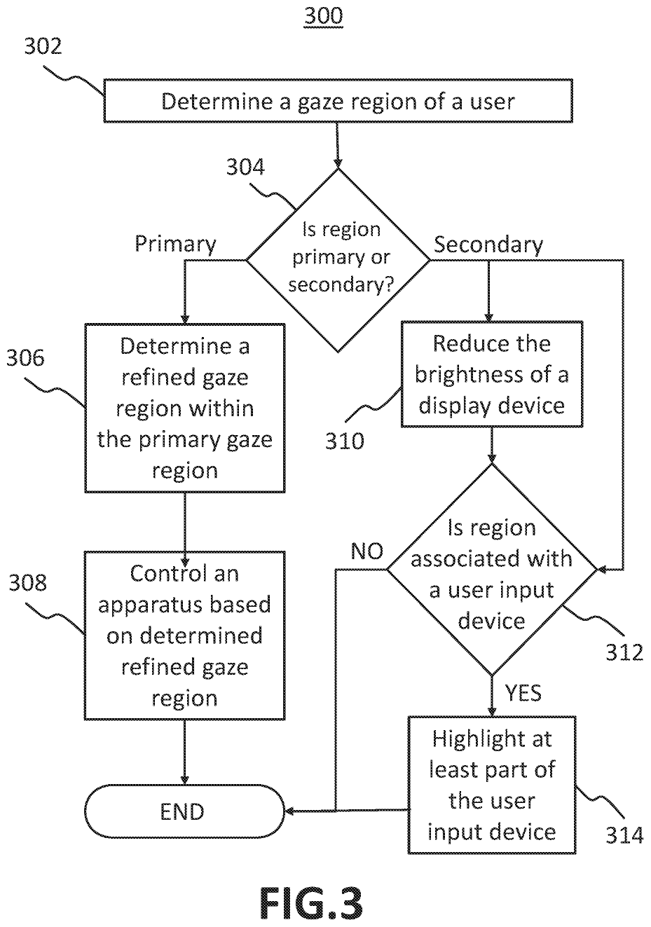

FIG. 3 a flow chart illustrating a method 300 of operating an apparatus based on the gaze of a user. The method operates in an environment such as those discussed in relation to FIGS. 1 and 2. As discussed above, the environment may have a plurality of regions 110, 112 associated with an apparatus. The plurality of regions 110, 112 comprises at least one primary gaze region 110 and at least one secondary gaze region 112. The method may be implemented by a processor, wherein an associated memory comprises instructions executable by the processor, as will be explained in relation to FIG. 5. The processor and memory may be implemented in the apparatus to be controlled, or remotely.

At step 302, the method comprises determining a gaze region of a user. Determining the gaze region can be performed using a first, lower-accuracy gaze estimation algorithm and/or a second, higher accuracy gaze estimation algorithm. In some embodiments, only the first gaze estimation algorithm is used. In other embodiments, only the second gaze estimation algorithm is used. In yet other embodiments, both the first and second gaze estimation algorithms are used.

In some embodiments, the first gaze estimation algorithm is a head pose estimation algorithm. Such algorithms are known in the art and will be discussed only in brief detail here. Head pose estimation algorithms can give an indication of where a user is looking based on determining a head pose of the user. This can be determined based on a three dimensional frame of reference, where (i) a three dimensional position indicates the location of the head, and where (ii) roll about a front-to-back axis, tilt about a left-to-right axis, and turn about a top-to-bottom axis can be measured to indicate the orientation of the user's head. When the user's head position has been determined, based on the assumption that the user generally looks straight ahead, the position of the user's gaze can also be determined. Whilst this approach is less accurate than some precise gaze point estimation algorithms, such as pupil centre cornea reflection (PCCR) which will be discussed below, it lends itself well to determining gaze regions as performed in step 302, which can be achieved using coarser or less accurate signals.

In other embodiments, the first gaze estimation algorithm determines a pupillary position of at least one eye of the user in order to determine where the user is looking. Such an approach is known in the art and will be discussed only in brief detail here. This can be achieved based on knowledge of the distance between the user's pupils with respect to a one or more facial landmarks, for example a nose, mouth, ear or other facial feature of the user. These can be determined when the user is looking forward, and then any changes in these distances can indicate a change in position of the pupil away from a forward-looking position. The position of the pupil can then be used to determine in which direction the user is looking. In some embodiments, at least three facial landmarks are used to determine a relative distance to the pupil. Similarly to head pose estimation, this approach is sometimes less accurate than precise gaze point estimation algorithms, but is well suited to determining a coarser gaze region as performed in step 302.

In other embodiments, the first gaze estimation algorithm comprises a machine-learning based gaze estimation algorithm. The algorithm may be trained based on a plurality of ground truth gaze locations generated by an apparatus rendering a visual stimulus. For example, the subject may be asked to look at one of an array of lights that are illuminated in different positions in the environment. These could be in any of the regions discussed in relation to FIGS. 1 and 2, or at any other point in the environment. For example, some of the stimulus points are normal points on the screen 102, as in a conventional data collection and calibration of eye-tracking systems. However, at certain times during the data collection, the subject is presented with stimuli that indicates a region (for example, an image of a keyboard to instruct the user to look at the keyboard 104). These ground truth gaze locations may be presented in two-dimensional and/or three-dimensional positions relative to the subject. The machine learning system can then observe the subject when looking at the different stimuli, and learn when the subject is looking at different regions. For example, the system may take an image of the subject when the subject is looking at a particular stimulus, and identify certain features from the image (for example the head pose or pupil position of the subject). The system may use this in combination with the geometry of the system, for example the distances between the subject, the stimuli and/or the device capturing the image of the subject. In this way, the algorithm learns features of an image of a user that indicate the user is looking at a particular location. The trained machine learning algorithm can then be used to determine when a user of an apparatus is looking at different regions associated with that apparatus. As with the algorithms discussed above, this approach may be less accurate than precise gaze point estimation algorithms, but is well suited to determining a coarser gaze region as performed in step 302.

By using only lower-accuracy gaze estimation algorithms to determine a gaze region at step 302, rather than the higher-accuracy algorithms that are typically used, the higher-accuracy algorithm need not be activated until it can be of use. That is to say, unless it is known that the user is within the working range of the higher-accuracy algorithm, for example looking at a primary gaze region such as region 110 corresponding to the screen 102 shown in FIG. 1, then the higher-accuracy algorithm is not used. This both saves computing resources associated with running the higher-accuracy algorithm all the time, and ensures erroneous signals that the higher-accuracy algorithm may produce when a user is not within its working range are not used to control an associated apparatus. In addition, if only a coarse estimation of gaze region, and not a precise estimation of a gaze point, is required, the infrastructure associated with higher-accuracy gaze estimation algorithms, such as eye tracking systems with illuminators used in corneal reflection techniques, need not be implemented in the overall system.

As discussed above, in some embodiments, only the second gaze estimation algorithm is used to determine a gaze region at step 302. In these embodiments, if the results of the second gaze estimation algorithm are considered to be of sufficient accuracy, then the method can proceed without use of the first gaze estimation algorithm. In the case that the results of the second gaze estimation algorithm are not considered to be of sufficient accuracy, for example if the user is looking outside the working range of the second algorithm, the first gaze estimation algorithm may be activated and used to determine the gaze region of the user. This implementation may be useful when it is known to be highly likely that the user is looking within the working range of the second algorithm, for example at a primary gaze region, and an accurate signal is desired.

As discussed above, in other embodiments, both the first and second gaze estimation algorithms are used to determine a gaze region at step 302. In these embodiments, the first gaze estimation algorithm may be run as discussed above and outputs a determined gaze region of the user. The second gaze estimation algorithm is also run and outputs its own determined gaze region of the user. In the case that the gaze regions determined by both algorithms is the same, for example both algorithms determine that the user is looking at region 110 corresponding to the screen 102 shown in FIG. 1, then the appropriate action can be taken in relation to that region.

In some embodiments, the first and second gaze estimation algorithms are configured to yield respective confidence signals associated with their respective determined gaze regions. These can be provided as a direct output of each algorithm, as would be readily appreciated by the person skilled in the art. In some embodiments, this can be performed relatively, where each algorithm estimates a gaze region and it is then determined how well the results agree in order to output a relative confidence signal. In the case that the gaze regions determined by the first and second gaze estimation algorithms are different, these confidence signals can be used to select either the gaze region determined by the first gaze estimation algorithm or the gaze region determined by the second gaze estimation algorithm. Specifically, the gaze region having the highest confidence signal may be selected. Once a selection of the gaze region has been made, the appropriate action can be taken in relation to that region.

In some embodiments, the second gaze estimation algorithm is a pupil centre cornea reflection (PCCR) algorithm. Such an approach is known in the art and will be discussed only in brief detail here. An eye-tracking system comprises at least one image capture device and at least one illuminator. In some embodiments, at least two illuminators are present at known relative positions. The at least one illuminator illuminates an eye of a user with light, for example infrared light, and uses the image capture device to detect reflection of the light from the eye. A processor may use the data from the image capture device to calculate, or otherwise determine, the direction of the user's gaze, based on the knowledge of the position of each of the at least one image capture device and the illuminator(s). This can result in a precise determination of where the user is looking within the working range of the eye-tracking system.

In other embodiments, the second gaze estimation algorithm comprises a machine-learning based gaze estimation algorithm. The algorithm may be trained based on a plurality of ground truth gaze locations generated by a display device rendering a visual stimulus. For example, the subject may be asked to look at a screen upon which a number of different attention points may be generated. The screen could be the screen 102 of the laptop computer 100 discussed in relation to FIG. 1. These ground truth gaze locations may be presented in two-dimensional and/or three-dimensional positions relative to the subject. In the case of a screen, one of the three-dimensional co-ordinates could be relatively constant for all ground truth gaze locations and may correspond to the distance between the subject and the screen. The machine learning system can then observe the subject when looking at the different stimuli, and learn when the subject is looking at different points on the screen. For example, the system may take an image of the subject when the subject is looking at a particular stimulus, and identify certain features from the image (for example the head pose or pupil position of the subject). The system may use this in combination with the geometry of the system, for example the distances between the subject, the display device and/or the device capturing the image of the subject. In this way, the algorithm learns features of an image of a user that indicate the user is looking at a particular location. The trained machine learning algorithm can then be used to determine where on a screen a user is looking.

Returning to FIG. 3, a determination is made as to whether the determined region is a primary gaze region or a secondary gaze region. It will be appreciated that this could be achieved in many ways. In one example, the gaze estimation algorithms may return a region ID that can be compared to a stored list of regions and their respective categories. Other ways of determining if a determined region is a primary gaze region or a secondary gaze region will be readily envisaged. Based on the determination made at step 304, the method 300 comprises performing at least one action based on the determination of the gaze region.

In the case that the determined gaze region is a primary gaze region, the method moves to step 306. At this step, performing at least one action comprises determining a refined gaze region. The refined region is an area that is smaller than the primary gaze region and located within the primary gaze region. For example, this may be the refined gaze region 114 that is within the primary gaze region 110 corresponding to the screen 102, as shown in FIG. 1. The refined region could be a gaze point of a user. As such, determining the refined gaze region could be performed using the second gaze estimation algorithm.

Once a refined gaze region has been determined, the method moves to step 308. At this step, performing at least one action further comprises controlling the apparatus based on the refined gaze region. This can involve activating the function of an icon on the screen if the refined region is determined to correspond to the position of that icon. Controlling the apparatus can also involve controlling a display device, such as the screen 102, based on the determined refined gaze region. This can include modifying the image at least in an area around the refined gaze region. When “modification” of an image presented on the display device is discussed herein, it shall be understood that what is intended is that at least a portion of a subsequent image displayed on the display device is different than at least a portion of a prior image displayed on the display device. This can include increasing or decreasing of image quality.

In the case that it is determined at step 304 that the gaze region is a secondary gaze region, the method moves to either step 310 or 312. If the primary gaze region primary gaze region comprises at least part of a display device associated with the apparatus, performing at least one action comprises reducing the brightness of the display device at step 310. This ensures that, whenever a user is looking away from the display device, for example screen 102, the energy consumption of the display device can be reduced as it is not required to provide full brightness while the user is not looking at it.

If the determined secondary gaze region is associated with a user input device associated with the apparatus, step 312 involves highlighting at least part of the user input device. A user input device may be any device with which the user can make an input to the apparatus, for example a keyboard 104, a pointing device such as a trackpad 106 or a mouse, or any other type of user input device. Some of such user input devices may include built-in illumination. In such cases, at step 314, highlighting at least part of the user input device comprises activating the built-in illumination of the user input device. By highlighting a user input device when it is determined that the user is looking at a region associated with that device, interaction with the device may be made simpler for the user. For example, in the case of a keyboard, individual keys may be highlighted so the user can more easily see what they are typing.

In the in-vehicle embodiments discussed above, if it is determined that the user is looking at a secondary gaze region, it may be desired to redirect the user's attention to the primary gaze region. For example, if the user is looking at the entertainment panel 204, and the safety system of the vehicle senses an obstacle up ahead, the system may generate an audio or visual alert to direct the user's attention to the primary gaze region 110. Similarly, if the safety system of the vehicle senses something behind the vehicle, the system may generate an audio or visual alert to direct the user's attention to the secondary gaze regions 112C-E associated with the mirrors 206A-B, 208 of the vehicle. This can enhance the safety features of the vehicle.

In other embodiments, if the determined secondary gaze region is associated with the instrument panel 202 and/or the entertainment panel 204, performing said at least one action may comprise controlling an illumination level of the panel in question. For example, if the user is looking at the instrument panel 202, the illumination of the instrument panel may be increased while the illumination level of the entertainment panel 204 may be decreased. Increasing illumination can make interaction with the panel that is being viewed simpler, whilst reducing illumination can reduce the risk of distraction. It will be appreciated that different combinations of audio and visual alerts and illumination levels can be implemented dependent on specific situations.

The actions disclosed above are examples of how the determination of a gaze region can be advantageous when an appropriate action is then taken. Many other actions in different environments that are based on the concepts disclosed above will be easily envisaged by the skilled person.

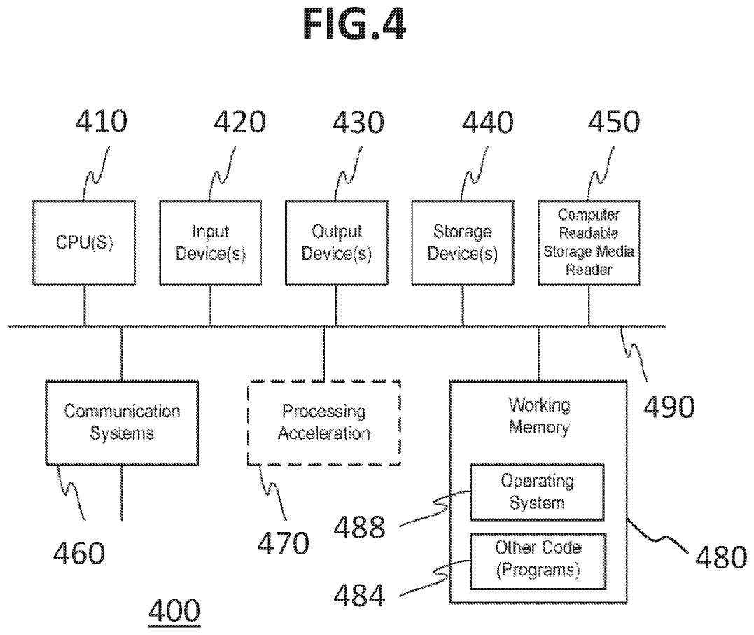

FIG. 4 is a block diagram illustrating an exemplary computer system 400 in which embodiments of the present invention may be implemented. This example illustrates a computer system 400 such as may be used, in whole, in part, or with various modifications, to provide the functions of the disclosed system. For example, various functions may be controlled by the computer system 400, including, merely by way of example, determining a user's gaze region, determining a user's gaze point, illuminating a device, dimming a display, etc.

The computer system 400 is shown comprising hardware elements that may be electrically coupled via a bus 490. The hardware elements may include one or more central processing units 410, one or more input devices 420 (e.g., a mouse, a keyboard, etc.), and one or more output devices 430 (e.g., a display device, a printer, etc.). The computer system 400 may also include one or more storage device 440. By way of example, the storage device(s) 440 may be disk drives, optical storage devices, solid-state storage device such as a random-access memory (“RAM”) and/or a read-only memory (“ROM”), which can be programmable, flash-updateable and/or the like.

The computer system 400 may additionally include a computer-readable storage media reader 450, a communications system 460 (e.g., a modem, a network card (wireless or wired), an infra-red communication device, Bluetooth™ device, cellular communication device, etc.), and a working memory 480, which may include RAM and ROM devices as described above. In some embodiments, the computer system 400 may also include a processing acceleration unit 470, which can include a digital signal processor, a special-purpose processor and/or the like.

The computer-readable storage media reader 450 can further be connected to a computer-readable storage medium, together (and, optionally, in combination with the storage device(s) 440) comprehensively representing remote, local, fixed, and/or removable storage devices plus storage media for temporarily and/or more permanently containing computer-readable information. The communications system 460 may permit data to be exchanged with a network, system, computer and/or other component described above.

The computer system 400 may also comprise software elements, shown as being currently located within the working memory 480, including an operating system 488 and/or other code 484. It should be appreciated that alternate embodiments of a computer system 400 may have numerous variations from that described above. For example, customized hardware might also be used and/or particular elements might be implemented in hardware, software (including portable software, such as applets), or both. Furthermore, connection to other computing devices such as network input/output and data acquisition devices may also occur.

Software of the computer system 400 may include code 484 for implementing any or all of the function of the various elements of the architecture as described herein. For example, software, stored on and/or executed by a computer system such as the system 400, can provide the functions of the disclosed system. Methods implementable by software on some of these components have been discussed above in more detail.

The invention has now been described in detail for the purposes of clarity and understanding. However, it will be appreciated that certain changes and modifications may be practiced within the scope of the appended claims.

1. A system configured to enable operation of an apparatus based on the gaze of a user, the system comprising:
a processor; and
a memory comprising instructions executable by the processor, wherein the system is configured to:
determine a gaze region of a user among a plurality of regions associated with the apparatus, wherein the plurality of regions comprises at least one primary gaze region and at least one secondary gaze region; and
perform at least one action based on the determination of the gaze region;
wherein the system is configured to determine the gaze region using a first gaze estimation algorithm and/or a second gaze estimation algorithm.

2. The system of claim 1, wherein the system is configured to determine the gaze region using only the first gaze estimation algorithm.

3. The system of claim 1, further configured to:
determine a gaze region using the first gaze estimation algorithm;
determine a gaze region using the second gaze estimation algorithm; and
select either the gaze region determined by the first gaze estimation algorithm or the gaze region determined by the second gaze estimation algorithm.

4. The system of claim 3, wherein:
the first and second gaze estimation algorithms are configured to yield respective confidence signals associated with their respective determined gaze regions; and
if the gaze regions determined by the first and second gaze estimation algorithms are different, the system is configured to select the gaze region having the highest confidence signal.

5. The system of claim 1, wherein the first gaze estimation algorithm comprises a head pose estimation algorithm configured to determine the gaze region based on a head pose of the user.

6. The system of claim 1, wherein the first gaze estimation algorithm is configured to determine a gaze region by determining a pupillary position of at least one eye of the user with respect to a plurality of facial landmarks, optionally at least three facial landmarks.

7. The system of claim 1, wherein the first gaze estimation algorithm comprises a first machine-learning based gaze estimation algorithm.

8. The system of claim 7, wherein the first machine-learning based gaze estimation algorithm is trained based on a plurality of ground truth gaze locations generated by an apparatus rendering a visual stimulus, wherein the ground truth gaze locations optionally comprise two-dimensional and/or three-dimensional locations.

9. The system of claim 1, wherein the second gaze estimation algorithm comprises a pupil centre cornea reflection “PCCR” algorithm.

10. The system of claim 1, wherein the second gaze estimation algorithm comprises a second machine-learning based gaze estimation algorithm.

11. The system of claim 10, wherein the second machine-learning based gaze estimation algorithm is trained based on a plurality of ground truth gaze locations generated by a display device rendering a visual stimulus, wherein the ground truth gaze locations optionally comprise two-dimensional and/or three-dimensional locations.

12. The system of claim 1, further comprising an image capture device, wherein the system is further configured to determine the gaze region using the image capture device.

13. The system of claim 12, further comprising an eye-tracking system comprising the image capture device and at least one illuminator, wherein the system is configured to determine the gaze region using the eye-tracking system.

14. The system of claim 13, wherein the at least one primary gaze region comprises locations that produce at least one corneal reflection detectable by the eye-tracking system when the user looks at such locations.

15. The system of claim 1, if the determined gaze region is a primary gaze region, performing at least one action comprises determining a refined gaze region that is smaller than the primary gaze region and located within the primary gaze region, wherein the refined gaze region is optionally a gaze point of the user.

16. The system of claim 15, wherein determining the refined gaze region comprises using the second gaze estimation algorithm.

17. The system of claim 15, wherein performing at least one action comprises controlling the apparatus based on the refined gaze region.

18. The system of claim 1, wherein the at least one primary gaze region comprises at least part of a display device associated with the apparatus.

19. The system of claim 18, wherein, if the determined gaze region is a secondary gaze region, performing at least one action comprises reducing the brightness of the display device.

20. The system of claim 1, wherein, if the determined gaze region is a secondary gaze region, performing at least one action comprises:
determining if the secondary gaze region is associated with a user input device associated with the apparatus; and, if so:
highlighting at least part of the user input device;
wherein highlighting at least part of the user input device optionally comprises activating built-in illumination of the user input device; and
wherein the user input device optionally comprises a keyboard and/or a pointing device.

21. The system of claim 1, wherein:
the apparatus is a computer associated with a vehicle;
the at least one primary gaze region corresponds to a straight-ahead view, an instrument panel and/or entertainment panel of the vehicle;
the at least one secondary gaze region corresponds to a side-view mirror and/or rear-view mirror of the vehicle; and
performing said at least one action optionally comprises causing the computer to:
control an illumination level of the instrument panel and/or entertainment panel; and/or
generate at least one audio or visual signal to direct the attention of the user to the straight-ahead view, instrument panel, entertainment panel, side-view mirror and/or rear-view mirror.

22. The system of claim 1, wherein at least one primary gaze region overlaps at least one secondary gaze region.

23. A method of operating an apparatus based on the gaze of a user, the method comprising:
determining a gaze region of a user among a plurality of regions associated with the apparatus, wherein the plurality of regions comprises at least one primary gaze region and at least one secondary gaze region; and
performing at least one action based on the determination of the gaze region;
wherein determining the gaze region comprises using a first gaze estimation algorithm and/or a second gaze estimation algorithm.

24. A computer program comprising instructions which, when executed on at least one processor, cause the at least one processor to carry out the method of claim 23.

25. A carrier containing the computer program of claim 24, wherein the carrier is one of an electronic signal, optical signal, radio signal, or computer readable storage medium.
